(19) United States
(12) Patent Application Publication
(10) Pub. No.: US 2018/0297792 A1
(43) Pub. Date: Oct. 18, 2018

(54) TRANSPORT MODULE FOR TRANSPORTING A CONTAINER AND A PROCESSING DEVICE AND A METHOD FOR TRANSPORTING A CONTAINER

(71) Applicant: Ferrum AG, Schafisheim (CH)

(72) Inventor: Thomas TRIEBEL, Niederweningen (CH)

(21) Appl. No.: 15/939,977

(22) Filed: Mar. 29, 2018

(30) Foreign Application Priority Data
Apr. 12, 2017 (EP) 17166335.4

(51) Int. Cl. B65G 47/86; B67C 7/00

(52) U.S. Cl. CPC B65G 47/847; B67C 7/0053; B67C 2007/0066; B67C 2007/006; B65G 2201/0252

(57) ABSTRACT

A transport module for transporting a container from a container source to a container receiver, the transport module includes a transport route with a transporter, the transport route between a reception area and a transfer area. A first holder configured to receive and hold the container is arranged and configured at the transporter in such a manner, that the container is grasped by the first holder in the reception area and the container is suspendingly transported along the transport route from the reception area to the transfer area, carried by the first holder.

### CROSS-REFERENCE TO RELATED APPLICATION

This application claims priority to European Application No. 17166335.4, filed Apr. 12, 2017, the contents of which are hereby incorporated herein by reference.

### BACKGROUND

### Field of the Invention

The invention relates to a transport module for transporting a container from a container source to a container receiver, in particular for transporting the container from a container dispenser to a filling station for filling the container or for transporting the container from a filling station for filling the container to a sealing module for sealing a container opening of a container by means of a lid and to a processing device for processing a container and to a method for transporting a container according to the preamble of the independent claim of the respective category.

### Background of the Invention

DE 42 36 784 A1, for example, discloses a generic transport module for transporting a container to a container receiver, which has been described inter alia in DE 749 636 or DE 42 34 115 A1 with a particular configuration of a sealing module.

Especially in the beverage industry, but not only, the common practice is to convey beverage cans after the filling process in a sealing module in the design of a can sealer by a transport module in the form of a so-called feeding table. This feeding table consists of a sliding belt, on which the cans are arranged in an upright position and are transported by a chain attachment. To prevent a lateral breakaway of the can flow, side guides limit a lateral movement of the cans. The sliding of the cans is crucial for a smooth running of the same, otherwise product loss could be caused by spillage, which may cause the beverage producer correspondingly significant loss over time, and in addition the spillage or leakage of the ingredients from the containers or cans may also result in unnecessary extra cleaning works, problems with the hygiene and so on.

The still open cans reach the so-called folding stations in the sealing module, e.g. in the can sealer, where they are applied with a lid and at the same time the headspace in the can is gassed with a protective gas or an inert gas to ensure the shelf life of the product. Then, the can on the folding station is set in rotation, while the folding station simultaneously rotates around the central axis of the sealing module. Since in practice usually several folding stations are used on a carrousel-like middle part of the sealing module, higher sealing rates are possible.

### SUMMARY

For a better understanding of the present invention, a transport module known from the state of the art in the form of a feeding table according to DE 42 34 115 A1 will first be described below with reference to FIG. 1. The feeding table briefly described above could, for example, essentially designed in this manner.

For a better distinction between the known state of the art and the present invention, reference signs referring to features of devices known from the state of the art have an inverted comma (in FIG. 1) or two inverted commas (FIGS. 2A and 2B), while features of devices or their compounds according to the invention have no inverted comma within the framework of this application.

In the known transport module 3′ according to FIG. 1, a container 1′, in the present example a metallic can 1′, previously filled with contents in a filling device, not shown in FIG. 1, is pushed on a rail 5′ of the transmodule 3′ in the direction of A′ by a finger 4a′ attached to a drive chain 4′ for receiving a beverage or for receiving another food or any other product. The can 1′ is guided on its opposite sides by a guide rail 6′ and a chain-side guide 13′. Then, the can 1′ is transferred to a can lifter 12′ of a sealing module 10′, which moves synchronously with the transport module 3′, and enters a recess 7a′ of a sealing rotary head 7′, which rotates in the circumferential direction U1′. When entering the sealing rotary head 7′, a recess 8a′, 15′ of an opposite rotary head 8′ or of a counter rotary head 8′, which is preferably arranged at a position symmetrical to the sealing rotary head 7′ and which rotates synchronized with the sealing rotary head 7′ in the reverse direction of rotation U2′, and the recess 7a′ of the sealing rotary head 7′ clamp the container 1′ on a line F′-F′ from opposite sides and center the container 1′ in a position suitable for sealing or hemming. After hemming a container lid 2′ with the container 1′ by a sealing roller or a hemming roller, not shown, the container 1′ sealed with the container lid 2′ moves via an ejector rotary head 9′ and an ejection rail 14′ in the direction B′ via a can ejector conveyer 9′ and is then fed to the next step in the sequence or process.

It is clear, that the known transport modules described above and to be improved by the invention are to be understood merely as examples of the systems which are currently used in the state of the art. Naturally, the invention also improves all known transmodules based on similar principles or functioning on similar principles, or most of such other transport systems can be replaced by a transport module according to the invention.

A special challenge in the field of packaging or conservation of products of all kind, such as beverages, food such as, for example, vegetables or fruits as well the packaging of other products such as mineral oils, lubricants and many other products, which are well known to the person skilled in the art, is, especially when using containers in the form of metallic cans, that the wall thickness of the containers, that is to say in particular the walls and lids delimiting the cans, should always become thinner in order to save resources for the production of cans, to reduce the expense of recycling the cans, but also to save weight when transporting and handling the cans in order to ensure ultimately not only a more economical but also a more environmentally friendly use of existing resources.

However, an unsolved problem in sealing containers and cans until now, whose wall thickness is being further reduced, is, that these containers, especially beverage cans or food cans or tin cans or containers for other products, no longer adequately withstand the radial and axial pressures required by the classical sealing methods, which pressures are necessary in the well-known classic methods for a perfect sealing of the container.

The applicant of the present application has already clearly recognized this problem earlier and has provided a solution with its PCT/EP2016/053764 in order to meet the needs of the market resulting from this problem, which solution largely or in particular completely avoids the described known problem with the radial pressure and the axial pressure, so that it is now possible for the first time by the applicant's invention mentioned above to reliably seal containers, in particular in the form of metallic cans regardless of the wall thickness of the container without the container or the lid being damaged or otherwise affected during sealing. Furthermore, it is possible for the first time by the invention, to reliably seal not only containers or cans with an almost arbitrarily low wall thickness. Now, also containers and cans of other materials, e.g. made of various plastics, biomaterials or other, in particular recyclable materials can be reliably sealed, because the applicant has fully solved the problem with the radial and axial pressure loads when sealing the containers by the invention mentioned above.

The problem with the axial pressure when sealing the containers existing up to the invention according to PCT/EP2016/053764 will be briefly outlined in the following for a better understanding.

The known sealing modules according to the state of the art comprise a clamping device for receiving the container to be sealed. In the operating state, the container to be sealed is introduced into the clamping device and secured by this in the axial and radial direction, so that the container is generally exposed to both axial and radial forces, which, as explained below, leads to the fact that the containers and lids must have a certain minimum wall thickness, otherwise they cannot adequately withstand the axially and radially acting forces. When sealing the container, a lid is further centrically inserted over the container opening of the container to be sealed. The container has a circumferential container flange in the region of the container opening and the lid has a circumferential lid flange. For sealing the container opening by the lid, the sealing module additionally comprises two folding rollers pivoted about an axis, which press the container flange together with the lid flange under a given force, wherein the pressing procedure is made by a continuous rolling in the circumferential direction along the circumference of the container opening.

Thus, a minimum stiffness of the lid and the container is required due to the forces acting on the container or the lid. In practice, therefore, there is a need to achieve this minimum stiffness of the lid and the container up to now by an appropriate choice of material and material thickness, and by an appropriate structure of the lid and the container. Furthermore, correspondingly large lid flange surfaces and container flange surfaces are also required in order to produce a sealing-safe folding bulge by means of the circumferential sealing method. All this results in a relatively high material consumption, which, as already mentioned, not only results in high material costs.

Another significant disadvantage of the previously described classical sealing module known up to PCT/EP2016/053764 is, that correspondingly high sealing times arise due to the mode of the pressing procedure, namely by the continuous rolling in the circumferential direction along the circumference of the container opening. This has a negative effect on the throughput and thus on the costs.

Furthermore, the classic structure of the sealing module involves high set-up times during a tool change for the operation on a different container geometry or lid geometry, because the clamping device and/or the folding rollers must be adjusted and/or replaced. Additionally, the use of the known sealing module is limited to round container openings, i.e. an opening without corners, and, in the operating state, the container opening must also be arranged in a horizontal plane when using the known sealing modules. Finally, the mode of the pressing procedure, namely by the continuous rolling in the circumferential direction along the circumference of the container opening, limits the folding form to two-dimensional, i.e. plane circumferential lines. As a result, no three-dimensional folding forms can be produced.

The applicant has already recognized all these problems earlier and has solved them reliably and successfully by the invention according to PCT/EP2016/053764 by a novel sealing module and a corresponding novel method for sealing containers, as will be outlined below for clarification with reference to FIG. 2A and FIG. 2B.

FIG. 2A shows a cross section through an example of a sealing module 1″ of the invention according to PCT/EP2016/053764. According to FIG. 2A, the sealing module 1″ comprises a supporting unit 8″ having a supporting surface 8a″ and a pressing unit 9″ having a pressing surface 9a″. The supporting surface 8a″ is formed as a supporting surface profile 8b″ and the pressing surface 9a″ as a corresponding pressing surface profile 9b″. The supporting unit 8″ is arranged immovably in the sealing module 1″ and the pressing unit 9″ is provided movably in the axial direction relative to an axis A3″ of the supporting unit 8″. The supporting unit 8″ is designed as a holding unit for supporting the container flange 6″. The container 2″ to be sealed is secured by the holding unit at the container flange 6″ in the axial direction to the axis A3″. In addition, the container 2″ is fixed by the holding unit in the axial direction to the axis A3″ and centered by a centering means or device.

As shown in FIG. 2B, the pressing unit 9″ is displaced in the axial direction towards the supporting unit 8″ during the sealing procedure. Here, the lid flange 7″ of the lid 3″ and the container flange 6″ are pressed together in such a form-locking manner by an axially acting pressing force F_{A}″ between the supporting surface profile 8b″ and the pressing surface profile 9b″, that no axial pressing forces F_{A}″ act on the can body DK″ as such. Then, after sealing, the container 2″ can be removed again from the supporting unit 8″ by the ejection element 12″.

In simple terms, the container 2″ to be sealed is hung up suspending freely by its container flange 6″ in the supporting surface 8a″ of the supporting unit 8″ and the lid 3″ is pressed together with its lid flange 7″ and the container flange 6″ with at least one pressing force F_{A}″ acting in the axial direction A3″ for sealing the container without exposing the container body DK″ to an axially acting pressing force F_{A}″, since the container body DK″ is freely hung up at its container flange 6″.

The fact, that at least no axial pressing forces F_{A}″ are acting on the container body DK″, the thickness of at least the container body DK″ can be reduced to an absolute minimum and thus, the amount of material required overall for the production of the container 2″.

Thus, the problems explained in the introduction in connection with the sealing of the containers have been solved indeed by the invention according to PCT/EP2016/053764. However, the containers, e.g. beverage cans, food cans or other containers to be sealed still have to be supplied to the sealing modules, both the novel sealing modules according to PCT/EP2016/053764 and the previously known sealing modules of the older type, of the corresponding next processing station with the classic transport modules described above, e.g. from a container dispenser providing the empty containers or from a filling station in which the containers are first filled.

The transport modules described above and known from the state of the art in form of classic feeding tables have a number of disadvantages that have not yet been resolved satisfactorily, regardless of the type of sealing module to which the feeding table supplies the containers to be sealed or regardless of the filling station to which the containers are supplied for filling.

Thus, up to now, it may be necessary to accept high changeover times, at least in certain cases during a tool change for operation on a different container geometry, since the containers, for example, no longer fit into the guide device of the feeding table. Either because the containers are too big, so that the guide devices of the feeding table can no longer receive the containers, or because the containers are too small or too big, i.e. for example, too narrow, too low or too high, so that they cannot be safely positioned in the guide device and as a result, the content, in particular liquid content, escapes from the containers during transport or the containers can even fall down from the transport module, since the containers can no longer be safely held on the transport module, for example on the feeding table. Furthermore, the use of the known transport modules such as the described feeding tables etc., is usually limited to a specific geometry of the containers, usually to round containers having a substantially circular radial cross section, i.e. limited to a corresponding geometry without corners. After all, the safe transfer of the containers from the transport module to a container receiver, e.g. to the sealing module, is basically a critical process step, which has to be ensured safely and reliably under all circumstances.

Thus, the object of the invention is to propose an improved transport module for transporting a container to a container receiver, in particular for transporting the container from a container dispenser to a container receiver in the form of a filling station for filling the container, or for transporting a container from a filling station for filling the container to a container receiver in the form of a sealing module for sealing a container opening of the container by means of a lid, which transport module solves the problems known from the state of the art, which transport module has a simplified and, with respect to the containers to be transported, flexible structure and in which the requirements for the material of container and/or lid are reduced regarding their stability or thickness. Additionally, the transport module should be flexibly adaptable to the different sealing modules in use and should be usable with these and should be optimally usable, in particular for the novel type of a sealing module described above, e.g. according to PCT/EP2016/053764, so that even very modern sealing modules, for example those of the type described according to FIG. 2A and FIG. 2B, can be optimally supplied with containers to be sealed. Thereby, shorter sealing times and also shorter changeover times should be additionally achievable, in which individual components of the transport module are easily and quickly exchangeable and in which moreover the containers are not limited to round or cylindrical geometries. Furthermore, a great simplification of the sealer is achieved.

Another object of the invention is to provide a corresponding processing device for processing a container and a corresponding method for transporting a container.

The objects of the invention meeting this problem are characterized by the features of the independent claim of the respective category.

The dependent claims relate to particularly advantageous embodiments of the invention.

Thus, the invention relates to a transport module for transporting a container from a container source to a container receiver, wherein the transport module comprises a transport route with a means or device for transporting, which transport route is disposed between a reception area and a transfer area. According to the invention, a first holding means for device or receiving and holding the container is arranged and configured in such a manner at the device for transport, that the container can be grasped by the first holding device in the reception area and that the container can be suspendingly transported along the transport route from the reception area to the transfer area, carried by the first holding device.

Thus, in the invention, the container can be suspendingly transported along the transport route from the reception area to the transfer area by the holding device. In other words, according to the present invention, the container is no longer on a transport belt and must be guided at least laterally with guide devices on the transport belt, but the container hangs rather freely suspending on the holding device during the transport process, so that no additional guiding or holding measures must be made as mandatory in the state of the art. Thus, not only no lateral guides are necessary anymore, but in addition, a transport module according to the invention does not need to be set up separately for a special container size or for a special container shape, since the holding device is suitable for all common container sizes and container shapes, because it simply carries them freely suspending, so that no additional guiding or holding measures must be made during the transport of the container. Thus, in a transport module according to the invention, it is also possible to dispense with the necessary elements known from the state of the art, such as table plates, sliding belts, etc., since these are not required in a freely suspending transport of the containers.

Further essential advantages of the transport module of the present invention result from the fact, that the precise transition, which was very difficult to manage in the state of the art, from the filler plate to the table plate of the feeding table, e.g. the transition of the container from a container source in the form of a filling station for filling the container to the transport module, is now very simple and in particular no longer needs to be set elaborately and carefully during installation. The known problems with the setting are also avoided by the use of a transport module according to the invention, whereby up to now it was usually necessary to distinguish between warm/cold operation of the system.

As already indicated, the devices for guiding the containers on the feeding table, i.e. on the transport module and for the most part in the sealing module, i.e. in the sealer, for example, no longer have to be carried out and even when changing tools, they no longer have to be adjusted or cleaned in a time-consuming manner.

Thus, practically all technically delicate transitions known from the state of the art between the container source and the transport module or between the transport module and the container receiver, i.e., for example, also on the feeding table as in the transition from the table plate to the sliding belt, from the sliding belt to the folding plate etc., are omitted by the invention. It is clear, that in doing so the entire sliding issue on the feeding table including the belt lubrication will become unnecessary.

When using an innovative sealer, for example according to PCT/EP2016/053764 as described by way of example with reference to FIG. 2A and FIG. 2B, no technically intricate middle part with adjusted lifting stations is required in the sealing module and in such a sealer, the stations on which the cans are sealed, no longer necessarily have to be rotated around its own axis during the sealing process, as it was previously mandatory in the known systems in the state of the art.

In a particularly preferred embodiment of a transport module according to the invention, the first holding device is designed in the form of a gripper, in particular as a gripper in the form of gripping tongs for grasping and holding the container. Then, the containers can be removed with the grippers, which e.g. are arranged at a distance of the divide between the filler and the sealer, from the filler and fed to the can sealer. The grippers grasp the cans at an upper neck area and hold them until they are transferred to the sealer. Grippers may then also be on the folding stations, which take over the arriving containers and also hold the containers in the neck area during the sealing process taking place about the central axis of the sealer.

It is clear, that for certain applications the first holding device for grasping and holding the container can also be designed as a contact module, in particular a vacuum assisted suction module or as a magnet assisted contact module or as an adhesively assisted contact module. Thus, as an alternative to the gripper or in addition to the gripper, the first holding device may comprise a suction head, which can be applied with a vacuum, so that the container sticks to the suction head due to the vacuum. It is also possible in very special cases, that the contact module has a special adhesive property and/or that it comprises an electromagnetic or a permanent-magnetic element, with which the container can be held on the holding device as an alternative to the gripper or to support the gripper, if the material of the container is magnetic, for example, or has special adhesive properties.

Of course, the container can also be held in any other suitable way by the holding element, for example by the gripper which does not enclose the container but clamps the container at a suitable section, for example on a bulge and thus holds the container securely. The person skilled in the art knows a whole set of other measures to ensure that a container can be held securely and reliably by a holding element.

The device for transporting or moving the first holding device can be suitably designed in a number of ways known per se to the person skilled in the art and in practice, will often comprise a transport chain driven by a drive and/or a transport belt driven by a drive or another drive technology known per se, such as a linear motor, for example, or other suitable, possibly magnetic field based drive technology, on which the first holding means for holding the container is suitably designed and functionally connected.

The invention further relates to a processing device for processing a container comprising a container source, a container receiver and a transport module of the present invention. In this case, the container can be transported by the transport module from the container source to the container receiver.

In practice, for example, the container source may be a container dispenser known per se for providing empty containers and/or the container receiver may be designed in the form of a filling station for filling the container with a filling material. Of course, the container source may also be designed in the form of a filling station for filling the container with a filling material and/or the container receiver is realized in the form of a sealing module for sealing the container by a lid. It will often be the case in practice, that the filling station works in parallel as a container receiver and as a container dispenser. The empty containers are supplied to the filling station from a corresponding container dispenser, in certain cases possibly by a transport module according to the invention, then the containers are filled in the filling station with a filling material, wherein the filled container is then transferred to another transport module according to the invention of the processing device, which finally conveys the filled container to a sealing module and transfers the container to the sealing module for sealing.

Of course, it is also advantageously possible with a processing device according to the invention, that the container source comprises a second holding device for receiving and holding the container and/or that the container receiver comprises a third holding device for receiving and holding the container, wherein the second holding device and/or the third holding device comprises a gripper, in particular a gripper in the form of gripping tongs for grasping and holding the container and/or wherein the second holding device and/or the third holding device comprises a contact module, in particular a vacuum assisted suction module or a magnet assisted contact module or an adhesively assisted contact module for grasping and holding the container.

This means that the components communicating with the transport module of the invention, such as, for example, the container source and/or the container receiver, can also be equipped with the above-mentioned holding devices, so that in particular the process of transferring or exchanging the containers between the transport module and the container source and/or between the transport module and the container receiver can be made smoothly and thus, not only the transport of the containers is optimized by the invention but also the exchange of the containers between the transport module according to the invention and the components communicating with this. The handling and transport of the containers within the container source and/or the container receiver can also be further improved or optimized by using the second and/or third holding device.

Finally, the invention also relates to a method for transporting a container from a container source to a container receiver by a transport module of the invention, in particular a method for transporting a container by using a processing device according to the invention, wherein the transport module comprising a transport route with a device for transporting is disposed between a reception area and a transfer area between the container source and the container receiver. In this embodiment, the container is received and held in the reception area by the container source by a first holding device disposed at the device for transporting, the container is suspendingly transported from the reception area to the transfer area carried by the first holding means and then the container is transferred to the container receiver in the transfer area.

As already described above and will be explained in more detail later with reference to the drawings, the container can be transferred in the reception area from the container source to the first holding device by a second holding device and/or the container can be transferred in the transfer area from the first holding device to the third holding device of the container receiver.

In a method according to the invention, as already mentioned, the second holding device and/or the third holding device may of course comprise a gripper, in particular a gripper in the form of gripping tongs for grasping and holding the container and/or the second holding device and/or the third holding device may comprise a contact module, in particular a vacuum assisted suction module or a magnet assisted contact module or an adhesively assisted contact module for grasping and holding the container.

In order to ensure an improved handling, i.e. receiving and holding the containers, the first holding device and/or the second holding device and/or the third holding device may comprise a gripper, in particular a gripper in the form of gripping tongs, wherein the first holding device and/or the second holding device and/or the third holding device encloses the container in a form-locking manner by the gripper on a recess and/or on a bulge of the container.

A container dispenser for providing empty containers can be used as a container source and/or a container receiver in the form of a filling station is advantageously used for filling the container with a filling material. Of course, a filling station for filling the container with a filling material can also be used as the container source and/or a container receiver in the form of a sealing module for sealing the container by a lid can also be advantageously used.

In practice, a transport module according to the invention or a processing device or a method for transporting containers according to the present invention is used particularly advantageously in the beverage industry, wherein a beverage can is used as the container and the beverage can is filled with a liquid food.

### BRIEF DESCRIPTION OF THE DRAWINGS

The invention will be explained in more detail hereinafter with reference to the drawings.

FIG. 1 is a transport module known from the state of the art;

FIG. 2A is a sealing module before the sealing process known from the state of the art;

FIG. 2B is the sealing module according to FIG. 2A during the sealing process;

FIG. 3A is schematically an embodiment of a processing device according to the invention with transport module;

FIG. 3B is an enlarged section of the transport route according to FIG. 3A;

FIG. 3C is a container from FIG. 3B with a recess and a bulge in the upper holding area of the container;

FIG. 4A is a special embodiment of a chain guide with container on a first holding means;

FIG. 4B is a functionality of the first holding means according to FIG. 4A from the view AN.

### DETAILED DESCRIPTION OF THE EMBODIMENTS

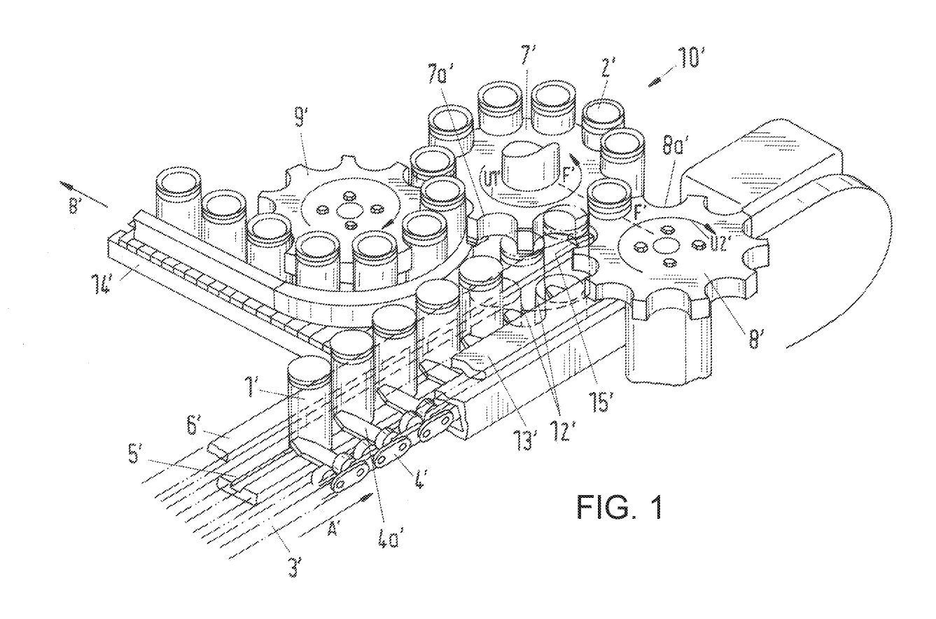

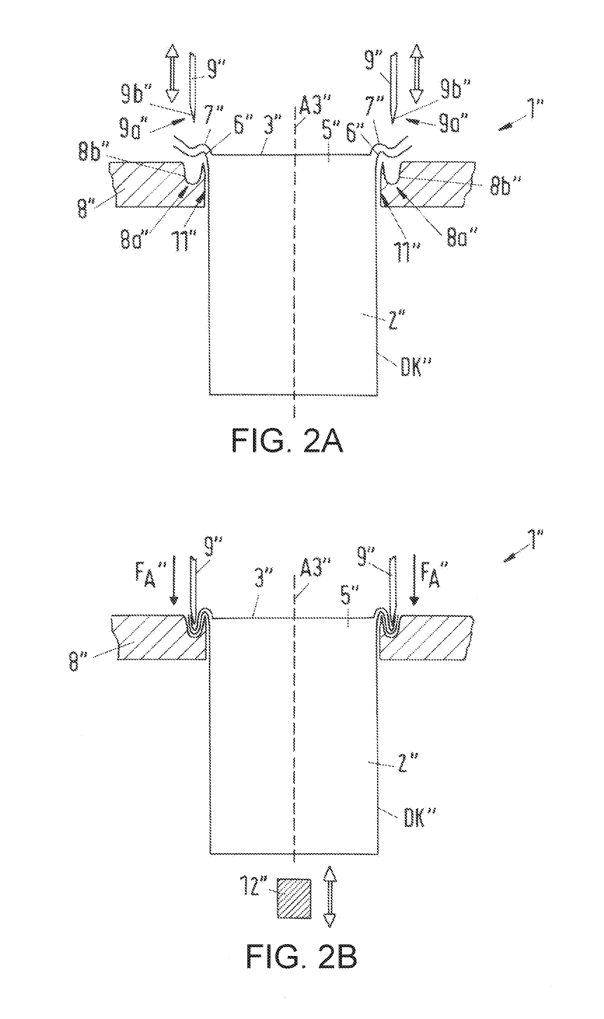

As already mentioned, FIG. 1 and FIG. 2A and FIG. 2B show the state of the art, which was already explained in detail at the beginning, so that further discussion is not necessary here.

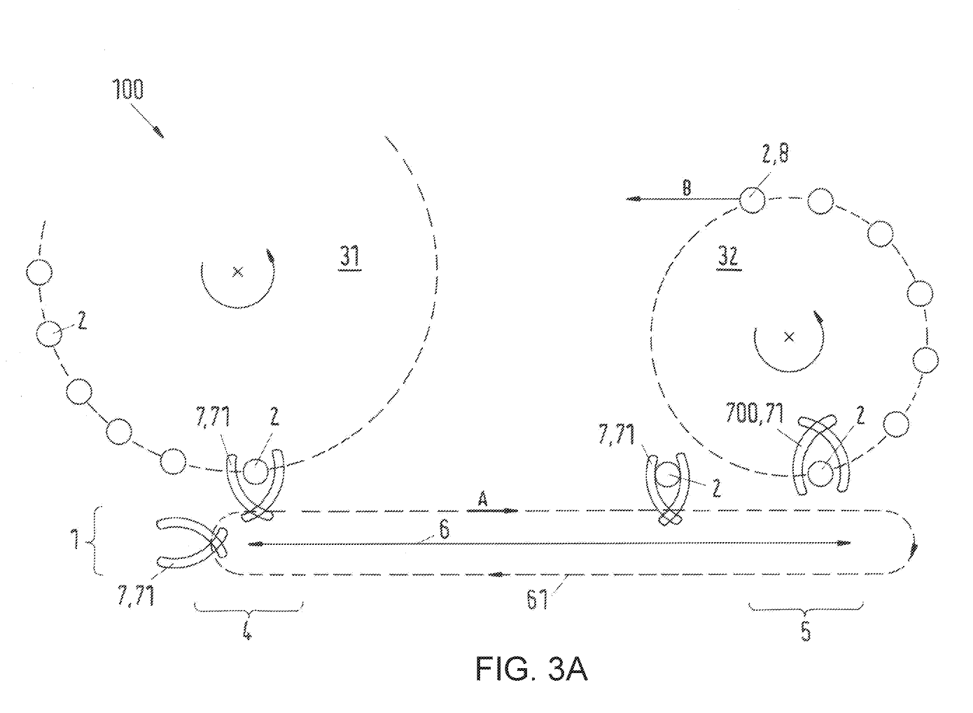

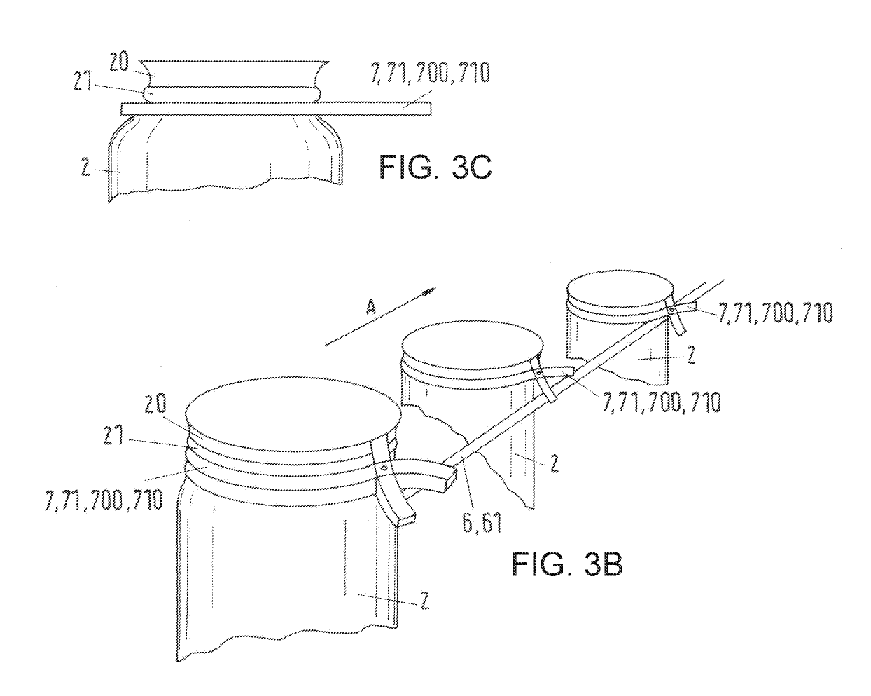

FIG. 3A, FIG. 3B and FIG. 3C schematically show a simple embodiment of a processing device 100 according to the invention with transport module 1, wherein with reference to FIG. 3B, an enlarged section of the transport route according to FIG. 3A is illustrated and FIG. 3C shows in detail a container from FIG. 3B with a recess and a bulge in the upper holding area of the container.

The transport module 1 serves to transport a container 2 from a container source 31 to a container receiver 32, wherein the transport module 1 comprises a transport route 6 with a means of transport or device for transporting (transporter) 61, which transport route is between a reception area 4 and a transfer area 5. According to the present invention, a first holding device (holder) 7, 71 for receiving and holding the container 2 is arranged and configured at the transporter 61, which here comprises a chain drive known per se, in such a manner, that the numerous containers 2 are grasped by the first holding device 7, 71 in the reception area 4 and that the containers 2 are suspendingly transported along the transport route 6 from the reception area 4 to the transfer area 5, carried by the first holding device 7, 71. As can be clearly seen from FIG. 3B, the containers 2, here beverage cans 2, are grasped by grippers 71, which are each in the form of gripping tongs, and are connected via these for transporting with the means of transport 61 in the form of a chain drive.

A container source 31, a container receiver 32 and the transport module 1 already mentioned are provided for processing the containers 2, so that the containers 2 can be transported from the container source 31 to the container receiver 32 by the transport module 1. In the present embodiment, according to FIG. 3A to FIG. 3C, the container source 31 is designed in the form of a filling station for filling the containers 2 with a filling material and the container receiver 32 is designed in the form of a sealing module for sealing the container 2 by lids 8.

In the present specific embodiment, the sealing module is a modern sealing module according to FIG. 2A or FIG. 2B, as the applicant has proposed, for example, in the PCT/EP2016/053764 already discussed at the beginning, the content of which is hereby incorporated into this application. The container receiver 32 comprises a third holding device (holder) 700 for receiving the containers 2 from the transport module 1, the third holding device 700 for grasping and holding the container 2 is designed here as a gripper 71, in the form of gripping tongs equal to or similar to the gripper 71 on the transport module 1.

As can be seen particularly well in FIG. 3C, the first holding device 7, 71 and also the third holding device 700 for grasping and holding the containers 2 are designed as grippers 71 in the form of gripping tongs, wherein the first holding device 7, 71, the third holding device 700 enclose the container in a form-locking manner and thus safely and reliably by the gripper 71 on a recess 20 or on a bulge 21 of the container 2 and thereby hold it.

In the operating state, the container source 31, which is a filling station in FIG. 3a to FIG. 3c, as said before, is supplied with empty containers 2 by a container dispenser (not shown here), these empty containers 2 are filled in the container source 31 with a filling material, for example with a beverage, then transferred to the first holding device 7, 71 in the form of a gripper 71 of the transport module 1, which transports the filled containers in the direction A to the container receiver 32 and transfers them to the third holding device 700, 71, which is also designed as a gripper 71, for sealing by the sealer of the container receiver 32. After the containers have been carefully sealed, they are ejected in the direction B for further processing, e.g. for forwarding to a packaging module for a ready to dispatch packaging of the containers.

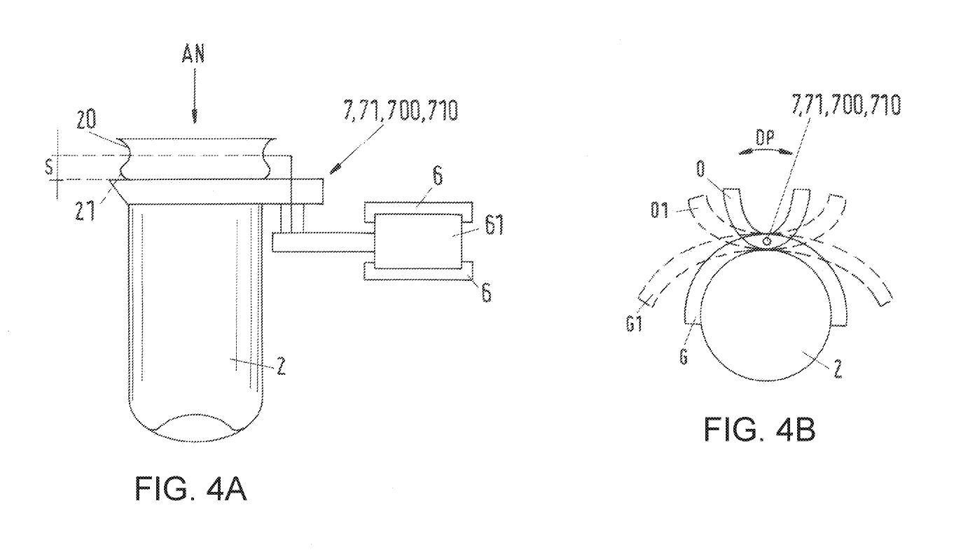

Finally, FIG. 4A shows a special embodiment of a chain guide with container 2 on a first or third holding device 7, 71, 700 of a transport module according to the invention or of a container receiver 32 of the invention, wherein the functionality of the first or the third holding devices according to FIG. 4A from the view AN is exemplarily illustrated by FIG. 4B. It is clear, that the second holding device of the container source 31, if it is designed in the form of a gripper, in practice is usually carried out analogously and also works as the first and third holding devices 7, 71, 700 described with reference to FIG. 4A or 4B.

As can be clearly seen in FIG. 4A, the container 2 is a beverage can, which is provided with an here annular recess 20 and an here annular bulge 21 at the upper end in the area of a neck area of the container for a better and more secure grasping by the first holding device 7, 71 being designed as gripping tongs or by the second holding device (holder) 710 being designed as gripping tongs or by the third holding device 710 being designed as gripping tongs. The gripping tongs are guided at the transporter 61 in the form of a chain drive known per se, which can be guided along the transport route 6. A sensor element S is disposed at the first, third or second holding device 7, 71, 700, 710, with which an opening or a closing of the holding device 7, 71, 700, 710 is initiated, when the container 2 is transferred from the container source 31 to the transport module 1 or when the container 2 is to be passed from the transport module to the container receiver 32. For clarity, FIG. 4 shows the holding device 7, 71, 700, 710 in different positions. Namely, in the fully closed state G, in which the container 2 is completely enclosed by the holding device 7, 71, 700, 710, so that the container 2 is safely held, in the half-closed state G1 or in the half-open state O1, which corresponds to a state in which the container is about to transfer to another module or shortly after the transfer to another module. Furthermore, the holding device 7, 71, 700, 71 is still illustrated in a fully open state O, in which the container 2 is released from the holding device 7, 71, 700, 71.

It is clear, that the particular embodiments of the invention discussed are to be understood as exemplary only and that the invention is of course not limited to these alone. In particular, the person skilled in the art understands that the described embodiments may be combined in any suitable manner and that, of course, simple developments of the claimed scope of patent, that are obvious to the person skilled in the art, are also included.

1. A transport module for transporting a container from a container source to a container receiver, the transport module comprising:
a transporter that travels on a transport route disposed between a reception area and a transfer area;
a first holder configured to receive and hold the container arranged and configured at the transporter such that the container is capable of being grasped by the first holder in the reception area and the container is capable of being suspendingly transported along the transport route from the reception area to the transfer area, carried by the first holder.

2. The transport module according to claim 1, the first holder comprises a gripper.

3. The transport module according to claim 1, wherein the first holder comprises a contact module.

4. The transport module according to claim 1, wherein the transporter comprises a transport chain driven by a drive or a transport belt driven by a drive configured to move the first holder.

5. A processing device for processing a container, comprising:
a container source;
a container receiver; and
a transport module according to claim 1, the container capable of being transported from the container source to the container receiver by the transport module.

6. The processing device according to claim 5, wherein the container source is a container dispenser configured to provide empty containers or the container receiver is a filling station configured to fill the container with a filling material.

7. The processing device according to claim 5, wherein the container source is a filling station configured to fill the container with a filling material or the container receiver is a sealing module configured to seal the container with a lid.

8. The processing device according to claim 5, wherein the container source comprises a second holder configured to receive and hold the container or the container receiver comprises a third holder configured to receive and hold the container, the second holder or the third holder comprising a gripper, or the second holder or the third holder comprising a contact module.

9. A method for transporting the container from the container source to the container receiver by the transport module according to claim 1, the transport module comprising transporter that travels on the transport route disposed between the reception area and the transfer area between the container source and the container receiver, the method comprising:
receiving and holding container by the container source in the reception area by a first holder disposed at the transporter;
suspendingly transporting the container from the reception area to the transfer area, while carried by the first holder; and
transferring the container to the container receiver in the transfer area.

10. The method according to claim 9, further comprising transferring the container from the container source to the first holder by a second holder in the reception area or transferring the container from the first holder to a third holder of the container receiver in the transfer area.

11. The method according to claim 10, wherein the second holder or the holder comprises a gripper or the second holder or the third holder comprises a contact module.

12. The method according to claim 10, wherein the first holder or the second holder or the third holder comprises a gripper and the first holder or the second holder or the third holder grips the container in a form-locking manner by the gripper on a recess or on a bulge of the container.

13. The method according to claim 9, wherein the container source is a container dispenser and provides empty containers or a container receiver in the form of a filling station fills the container with a filling material.

14. The method according to claim 9, wherein the container source is a filling station for filling the container with a filling material or a container receiver in the form of a sealing module seals the container by a lid.

15. The method according to claim 9, wherein the container is a beverage can filled with a liquid food.

16. The transport module according to claim 1, the first holder comprises gripping tongs configured to grasp and hold the container.

17. The transport module according to claim 1, wherein the first holder comprises a vacuum assisted suction module or a magnet assisted contact module or an adhesively assisted contact module configured to grasp and hold the container.

18. The processing device according to claim 5, wherein the container source comprises a second holder configured to receive and hold the container or the container receiver comprises a third holder configured to receive and hold the container, the second holder or the third holder comprising a gripper, or the second holder or the third holder comprising a vacuum assisted suction module or a magnet assisted contact module or an adhesively assisted contact module configured to grasp and hold the container.

19. A method for transporting the container from the container source to the container receiver by the transport module according to claim 5, the transport module comprising transporter that travels on the transport route disposed between the reception area and the transfer area between the container source and the container receiver, the method comprising:
receiving and holding container by the container source in the reception area by a first holder disposed at the transporter;
suspendingly transporting the container from the reception area to the transfer area, while carried by the first holder; and
transferring the container to the container receiver in the transfer area.

20. The method according to claim 10, wherein the second holder or the holder comprises gripping tongs configured to grasp and hold the container or the second holder or the third holder comprises a vacuum assisted suction module or a magnet assisted contact module or an adhesively assisted contact module configured to grasp and hold the container.
